(19) United States
(12) Patent Application Publication
(10) Pub. No.: US 2017/0149055 A1
(43) Pub. Date: May 25, 2017

(54) LITHIUM-ION SECONDARY BATTERY

(71) Applicant: Panasonic Intellectual Property Management Co., Ltd., Osaka (JP)

(72) Inventors: YOSHIE TAKAHASHI, Osaka (JP); TAKAO KUROMIYA, Osaka (JP)

(21) Appl. No.: 15/286,563

(22) Filed: Oct. 6, 2016

(30) Foreign Application Priority Data
Nov. 19, 2015 (JP) 2015-226153
Aug. 3, 2016 (JP) 2016-152387

(51) Int. Cl. H01M 4/36; H01M 4/587; H01M 4/133; H01M 4/38; H01M 10/0525; H01M 4/134

(52) U.S. Cl. CPC H01M 4/364; H01M 10/0525; H01M 4/134; H01M 4/133; H01M 4/386; H01M 4/587

(57) ABSTRACT

Provided herein, is a lithium-ion secondary battery having desirable charge and discharge cycle characteristics. The negative electrode active material as a constituent material of the negative electrode mixture layer has a flat surface in at least a part of its surface. This can improve the charge and discharge cycle characteristics.

### TECHNICAL FIELD

The technical field relates to a lithium-ion secondary battery that is configured to include a negative electrode plate including a negative electrode collector and a negative electrode mixture layer, and a positive electrode plate.

### BACKGROUND

Lithium-ion secondary batteries are a type of secondary batteries with high operating voltage and nigh energy density, and have been put to practical applications as a power supply for driving cell phones, laptop personal computers, and other mobile electronic devices such as mobile phones. The growth of lithium-ion secondary batteries has been rapid, and its production has been increasing as a system of batteries that leads the way for small secondary batteries.

Lately, a demand for lithium-ion secondary batteries has also increased in batteries for automobiles, in addition to smaller commercial applications such as above, and there is ongoing development of high-energy-density lithium-ion secondary batteries. Increasing the capacity of negative electrode material is also considered important as the capacity of positive electrode material continues to increase in lithium-ion secondary batteries. With regard to high-capacity negative electrode active materials, materials that can store and release more lithium ions, such as silicon (Si) and tin (Sn), have attracted interest as alternative materials to graphite and other carbon-based materials traditionally used in lithium-ion secondary batteries. Particularly, SiOₓ, which has a structure with fine particles of silicon dispersed in SiO₂, is reported to have desirable characteristics, including desirable load characteristics.

However, because of the large volume expansion and contraction, due to charge and discharge reaction, SiOₓ is known to have a number of drawbacks, such as irreversible capacity increase of the negative electrode caused when the silicon that has precipitated on the negative electrode surface reacts with the nonaqueous electrolytic solution solvent following pulverization of silicon particles occurring in every charge and discharge cycle of battery. Another drawback is swelling of a battery canister due to the generated gas in the battery as a result of such reactions.

Various techniques are proposed against such problems (see, for example, JP-A-2011-233245). In one technique, the SiOₓ content, or the mass ratio of positive electrode active material and negative electrode active material is limited to reduce the volume expansion and contraction due to charge and discharge reaction. Another technique improves the load characteristics by coating the SiOₓ surface with conductive materials such as carbon. In another example, a nonaqueous electrolytic solution prepared by adding a halogen-substituted cyclic carbonate is used to improve charge and discharge cycle characteristics.

### SUMMARY

The configuration of the related art uses SiOₓ as negative electrode active material, and some of SiO₂ reacts with lithium ions to form lithium silicate. This increases the irreversible capacity, and lowers the initial charge and discharge efficiency. Given the demand for a longer battery life to meet the increasing demand for automobile applications, there is a need to improve charge and discharge cycle characteristics.

The present disclosure is intended to solve the foregoing problems, and it is an object of the present disclosure to improve charge and discharge cycle characteristics.

In order to achieve the foregoing object, a lithium-ion secondary battery of an embodiment of the present disclosure includes:

positive electrode plate including a positive electrode collector, and a positive electrode mixture layer provided in contact with a surface of the positive electrode collector;

a negative electrode plate including a negative electrode collector, and a negative electrode mixture layer provided in contact with a surface of the negative electrode collector; and

a separator provided between the positive electrode plate and the negative electrode plate,

the positive electrode plate, the negative electrode plate, and the separator being housed in a casing with an electrolytic solution,

wherein the negative electrode mixture layer includes at least a first negative electrode active material, and a binder that anchors the first negative electrode active material on a surface of the negative electrode collector,

wherein the first negative electrode active material has a structure in which silicon fine particles are dispersed in at least an inorganic compound, and

wherein the first negative electrode active material has a flat surface in at least a part of its surface.

With this configuration, a lithium-ion secondary battery having desirable charge and discharge cycle characteristics can be provided.

The charge and discharge cycle characteristics can improve when a flat surface is formed on the negative electrode active material constituting the negative electrode mixture layer, as stated above.

### BRIEF DESCRIPTION OF THE DRAWINGS

FIG. 1 is a cross sectional view illustrating a configuration of a lithium-ion secondary battery.

FIG. 2 is a schematic diagram illustrating a configuration of a negative electrode plate in an embodiment of the present disclosure.

FIG. 3 is a schematic diagram illustrating a preferred configuration of a negative electrode active material in an embodiment of the present disclosure.

FIG. 4 is a schematic diagram illustrating a preferred configuration of a negative electrode active material in an embodiment of the present disclosure.

FIG. 5 is a schematic diagram illustrating a configuration of an inappropriate negative electrode active material.

FIG. 6 is a schematic view illustrating a sequence of negative electrode mixture layer formation in an embodiment of the present disclosure.

FIG. 7 is a cross sectional schematic view illustrating changes in the configuration at the negative electrode active material during charge and discharge in an embodiment of the present disclosure.

FIG. 8 is a schematic diagram illustrating a configuration of the negative electrode active material in an embodiment of the present disclosure.

FIG. 9 is a schematic diagram illustrating a configuration of an inappropriate negative electrode mixture layer.

FIG. 10 is a schematic diagram illustrating a configuration of an inappropriate negative electrode mixture layer.

FIG. 11 is a diagram representing the results of battery performance measurements performed in Examples 1 to 9 and Comparative Examples 1 to 6.

### DESCRIPTION OF EMBODIMENTS

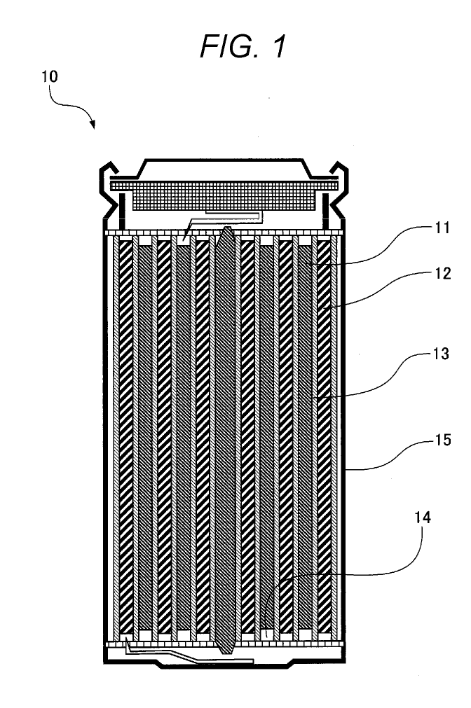

An embodiment of the present disclosure is described below with reference to the accompanying drawings. FIG. 1 is a cross sectional view illustrating a configuration of a lithium-ion secondary battery.

As shown in FIG. 1, a lithium-ion secondary battery 10 of an embodiment of the present disclosure is configured from, for example, an electrode unit including a positive electrode plate 11, a negative electrode plate 12, and a separator 13; a nonaqueous electrolytic solution 14; and a casing 15 housing these components.

The positive electrode plate 11, the separator 13, the nonaqueous electrolytic solution 14, and the casing 15 are not particularly limited in the lithium-ion secondary battery 10 of the embodiment of the present disclosure, and may be, for example, as follows.

The positive electrode, plate 11 includes a positive electrode collector made from a conductive film, and a positive electrode mixture layer provided on at least one surface of the positive electrode collector. The positive electrode collector is not particularly limited, and may be made of the same materials that are used traditionally, including, for example, a metal foil or an expanded metal of aluminum, an aluminum alloy, titanium, copper, or nickel, a laminate of a metal vapor deposited en a surface of a polymer film such as PET, and a conductive polymer film. The positive electrode mixture layer includes at least a positive electrode active material, a conduction aid, and a binder. The positive electrode active material may use, for example, lithium-containing composite metal oxides such as lithium nickel oxide, lithium cobalt oxide, and lithium manganese oxide. (These are typically represented as LiNiO₂, LiCoO₂, and LiMn₂O₄; however, the Li:Ni ratio, the Li: Co ratio, and the Li:Mn ratio often deviate from the stoichiometric compositions.) The lithium-containing composite metal oxides are not particularly limited, and may be used alone or as a mixture of two or more, or may be used as a solid solution thereof. The conduction aid is not particularly limited, and may be, for example, carbon black (such as Ketjen black, and acetylene black), fiber-like carbon, or scale-like graphite. The binder may be, for example, a thermoplastic resin, a polymer having rubber elasticity, or a polysaccharide, which may be used alone or as a mixture. Specific examples of the binder include, but are not particularly limited to, a copolymer of polytetrafluoroethylene or polyvinylidene fluoride with hexafluoropropene, polyethylene, polypropylene, an ethylene-propylene-diene copolymer, styrene-butadiene rubber, polybutadiene, fluororubber, polyethylene oxide, polyvinylpyrrolidone, a polyester resin, an acrylic resin, a phenolic resin, epoxy, polyvinyl alcohol, and cellulose resins such as hydroxypropyl cellulose, and carboxymethyl cellulose.

The separator 13 is not particularly limited, as long as it is a material that insulates the positive electrode plate 11 and negative electrode plate 12 from each other, and that allows movement of lithium ions therein (through the material of the separator 13, or through the pores formed inside the separator 13), in addition to being stable during the use of the lithium-ion secondary battery 10. Examples of such materials include an insulating polymer porous film of polyethylene or polypropylene, and an insulating nonwoven fabric of cellulose. The separator 13 also may be formed by applying, drying, and rolling a mixture of different materials, including, for example, particles of inorganic materials such as alumina, silica, magnesium oxide, titanium oxide, zirconia, silicon carbide, and silicon nitride, particles of organic materials such as polyethylene, polypropylene, polystyrene, polyacrylonitrile, polymethylmethacrylate, polyvinylidene fluoride, polytetrafluoroethylene, and polyimide, mixtures of such inorganic and organic particles, a binder, a solvent, and various additives. The thickness of the separator 13 is not particularly limited, and is, for example, 10 μm to 50 μm.

The nonaqueous electrolytic solution 14 includes a nonaqueous solvent, and an electrolyte. The nonaqueous solvent is not particularly limited, and may be, for example, ethylene carbonate, propylene carbonate, butylene carbonate, dimethyl carbonate, methyl ethyl carbonate, diethyl carbonate, γ-butyrolactone, sulfolane, acetonitrile, 1,2-dimethoxyethane, 1,3-dimethoxypropane, diethyl ether, tetrahydrofuran, 2-methyltetrahydrofuran, or γ-butyrolactone. The nonaqueous solvent may be used alone or as a mixture of two or more. In order to form a desirable coating on the positive electrode plate 11 and the negative electrode plate 12, or to ensure stability during overcharge, it is also preferable to use vinylene carbonate (VC) or cyclohexylbenzene (CHB), or a modified product thereof as the nonaqueous solvent. The nonaqueous solvent is not limited to the materials exemplified above, and certain electrolytic solutions may be used. The electrolyte of the nonaqueous electrolytic solution 14 is not particularly limited, and may be a lithium salt, for example, such as lithium perchloride (LiClO₄), lithium hexafluorophosphate (LiPF₅), lithium tetrafluoroborate (LiBF₄), lithium hexafluoroarsenate (LiAsF₅), lithium trifluoromethanesulfonate (LiCF₃SO₃), and lithium bis(trifluoromethylsulfonyl) imide [LiN(CF₃SO₂)₂].

The casing 15 is not particularly limited, and may be, for example, a molded material of metals such as aluminum, iron, and stainless steel, or a laminated film of a metal layer such as aluminum, and a polymer layer.

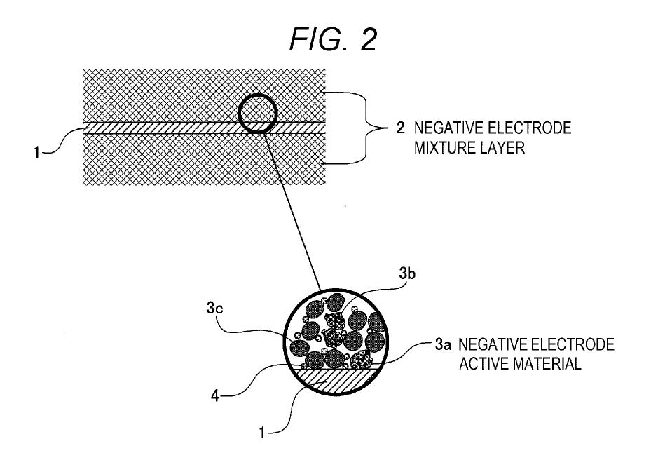

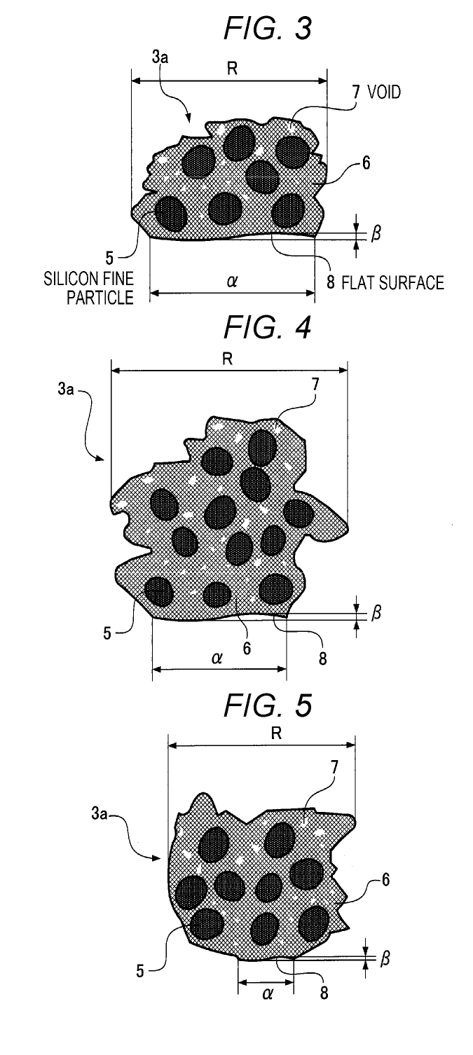

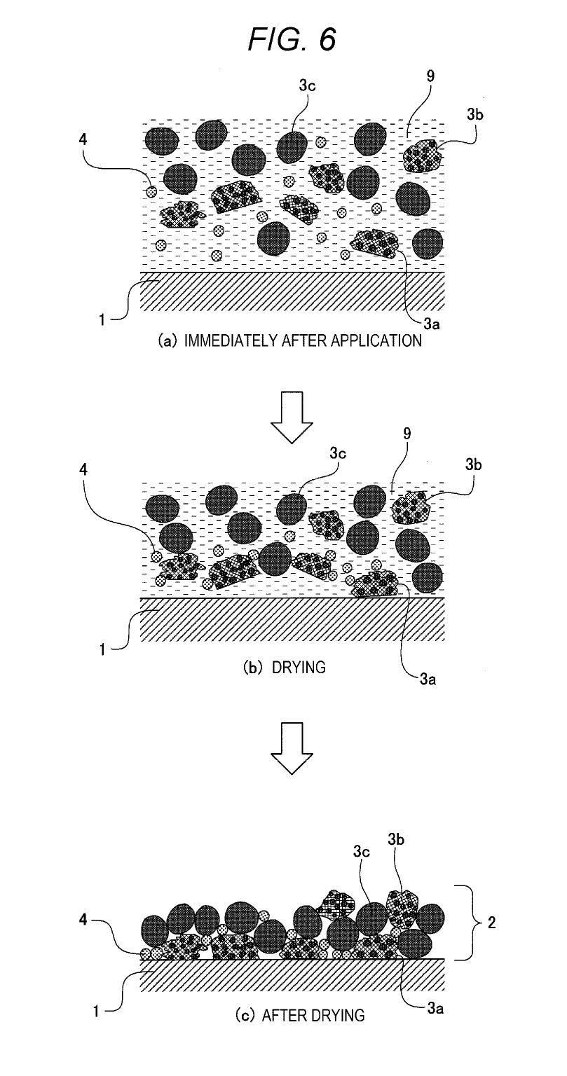

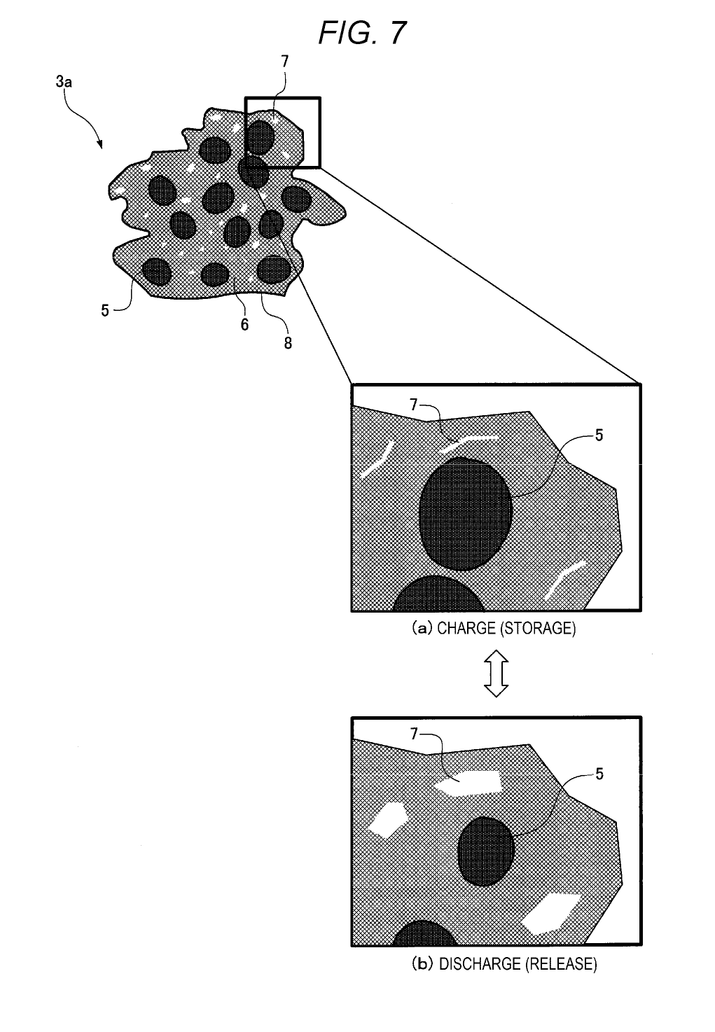

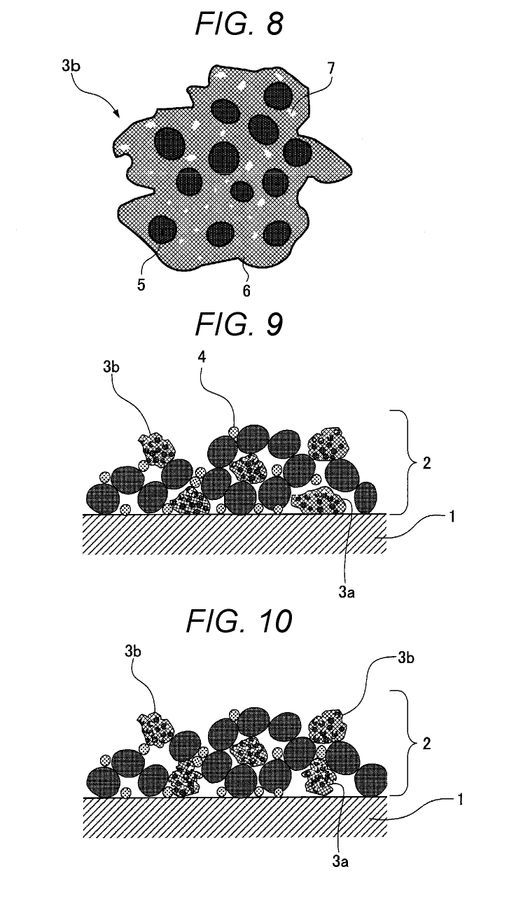

The negative electrode plate, a characteristic feature of the present disclosure, is described below in detail with reference to FIGS. 2 to 10. FIG. 2 is a schematic diagram illustrating a configuration of the negative electrode plate in the embodiment of the present disclosure, along with an enlarged view of the circled portion. FIGS. 3 and 4 are schematic diagrams illustrating a preferred configuration of a negative electrode active material in the embodiment of the present disclosure. FIG. 5 is a schematic diagram illustrating a configuration of an inappropriate negative electrode active material. FIG. 6 is a schematic view illustrating a sequence of negative electrode mixture layer formation in the embodiment of the present disclosure. FIG. 7 is a cross sectional schematic view illustrating changes in the configuration of the negative electrode active material during charge and discharge in the embodiment of the present disclosure. FIG. 8 is a schematic diagram illustrating a configuration of the negative electrode active material in the embodiment of the present disclosure. FIGS. 9 and 10 are schematic diagrams illustrating configurations of inappropriate negative electrode mixture layers.

The negative electrode plate 12 includes a negative electrode collector 1 formed of a conductive film, and a negative electrode mixture layer 2 provided on at least one surface of the negative electrode collector 1, as shown in FIG. 2. FIG. 2 illustrates a configuration in which the negative electrode collector 1 is sandwiched between the negative electrode mixture layers 2, and as such the negative electrode mixture layer 2 is provided on the both surfaces, top and bottom, of the negative electrode collector 1.

The negative electrode collector 1 is not particularly limited, and may be made of the same materials that are used traditionally, including, for example, a metal foil or an expanded metal of copper, aluminum, an aluminum alloy, titanium, or nickel, a laminate of a metal vapor deposited on a surface of a polymer film such as PET, and a conductive polymer film.

The negative electrode mixture layer 2 includes at least a negative electrode active material (first negative electrode active material) 3a, and may include negative electrode active materials 3b and 3c. The negative electrode mixture layer 2 also includes a binder 4 for anchoring the negative electrode active materials 3a, 3b, and 3c on the surfaces of the negative electrode collector 1. The binder 4 may be the same material used for the positive electrode plate 11 (see FIG. 1), for example, such as a thermoplastic resin, a polymer having rubber elasticity, and polysaccharides, which may be used either alone or as a mixture. Specific examples of the binder 4 include, but are not limited to, a copolymer of polytetrafluoroethylene or polyvinylidene fluoride with hexafluoropropene, polyethylene, polypropylene, an ethylene-propylene-diene copolymer, styrene-butadiene rubber, polybutadiene, fluororubber, polyethylene oxide, polyvinylpyrrolidone, a polyester resin, an acrylic resin, a phenolic resin, epoxy, polyvinyl alcohol, and cellulose resins such as hydroxypropyl cellulose, and carboxymethyl cellulose.

The negative electrode active material 3a has such a structure that silicon fine particles 5 are dispersed in an inorganic compound 6, as shown in FIGS. 3 and 4.

The silicon fine particles 5 are larger than 5 nm and less than 1,000 nm, more preferably larger than 5 nm and less than 200 nm in size. When the silicon fine particles 5 are fine particles of less than 200 nm, volume changes due to expansion and contraction of the silicon fine particles 5 during charge and discharge can be reduced. With the structure in which the inorganic compound 6 is covering the silicon fine particles 5, the expansion and contraction of the silicon fine particles 5 can be reduced. On the other hand, when the silicon fine particles 5 are 200 nm or more, large volume changes occur due to expansion and contraction of the silicon fine particles 5 during charge and discharge, and problems such as cracking tend to occur even with the structure in which the silicon fine particles 5 are covered by the inorganic compound 6. However, it takes a longer time to produce silicon fine particles of less than 200 nm, and the cost increases. Preferably, the silicon fine particles 5 are less than 1,000 nm because particles of such a particle size can be produced at lower cost, though volume changes due to expansion and contraction are larger, and problems such as cracking is more likely to occur than when the particle size is 200 nm.

The inorganic compound 6 may have voids 7, in addition to or separately from the foregoing configuration. The negative electrode active material 3a has a flat surface 8 in a part of its surface.

The flat surface 8 is a flat portion of the surface in the solid shape of the negative electrode active material 3a. The flat surface 8 has a linear shape as observed in a cross section of the negative electrode active material 3a. The ratio (β/α) of the length α and the straightness β of the straight line portion is preferably less than 0. 07. The ratio (α/R) of the length a of the straight line portion and the particle size R of the negative electrode active material 3a is preferably larger than 0.3. The binder 4 anchors the negative electrode active material 3a on the surfaces of the negative electrode collector 1, and forms the negative electrode mixture layers 2. The area of contact between the negative electrode active material 3a and the negative electrode collector 1 increases, and the adhesion between the negative electrode mixture layers 2 and the negative electrode collector 1 improves by containing the negative electrode active material 3a (FIGS. 3 and 4) having the flat surface 8 in which the ratio (β/α) between the length α and the straightness β of the straight line portion is less than 0.07, and the ratio (α/R) between the length a of the straight line portion and the particle size R of the negative electrode active material 3a is larger than 0.3 . FIG. 5 illustrates an example of a configuration in which the ratio (β/α) between the length a and the straightness β of the straight line portion is less than 0.07, and the ratio (α/R) between the length α of the straight line portion and the particle size R of the negative electrode active material 3a is 0.3 or less, specifically a configuration in which the ratio (α/R) between the length α of the straight line portion and the particle size R of the negative electrode active material 3a is 0.25.

As shown in FIG. 6, formation of the negative electrode mixture layer 2 involves applying a solution of the negative electrode active materials 3a, 3b, and 3c, the binder 4, and a solvent 9 onto the negative electrode collector 1, using an applicator, for example, such as a die (immediately after application in (a) of FIG. 6). In the next drying process for drying the solvent 9 (drying in (b) of FIG. 6), the negative electrode active materials 3a, 3b, and 3c form the negative electrode mixture layer 2 as they move under the convection created by the drying. Because of the flat surface 8 in which the ratio (β/α) between the length α and the straightness β of the straight line portion is less than 0.07, and the ratio (α/R) between the length a of the straight line portion and the particle size R of the negative electrode active material 3a is larger than 0.3, a strong adhesion force acts between the negative electrode active material 3a having the flat surface 8 and the negative electrode collector 1 as the negative electrode active materials 3a, 3b, and 3c move in the solvent 9 under the convection, and the negative electrode mixture layer 2 is formed with the flat surface 8 of the negative electrode active material 3a providing a point of contact with the negative electrode collector 1 upon drying the solvent with the flat surface 8 held in contact with the negative electrode collector 1 (after drying in (c) of FIG. 6). This increases the contact points between the negative electrode collector 1 and the negative electrode material 3a, and the adhesion between the negative electrode collector 1 and the negative electrode mixture layer 2 can improve. This makes it possible to reduce the deterioration of collectability as might occur, for example, when the negative electrode mixture layer 2 detaches itself from the negative electrode collector 1, and the lithium-ion secondary battery 10 can have desirable charge and discharge cycle characteristics. However, the advantage of having the flat surface becomes not as effective, and the effect that improves the adhesion between the negative electrode collector 1 and the negative electrode mixture layer 2 cannot be obtained when the negative electrode active material 3a used has a flat surface in which the ratio (β/α) between the length α and the straightness β of the straight line portion is less than 0.07, and the ratio (α/R) between the length α of the straight line portion and the particle size R of the negative electrode active material 3a is 0.3 or less (FIG. 5). The adhesion for the negative electrode collector becomes poor, and poor charge and discharge cycle characteristics result when the ratio (β/α) between the length α and straightness β of the straight line portion is 0.0or more, and the particles do not have a flat surface. It is therefore preferable that the silicon fine particles 5 have a flat surface 8 in which the ratio (β/α) between the length a and the straightness β of the straight line portion is less than 0.07, and the ratio (α/R) between the length α of the straight line portion and the particle size R of the negative electrode active material 3a is larger than 0.3.

In order to form a flat surface on the negative electrode active material 3a, for example, an inorganic compound 6 with the sample silicon fine particles 5 dispersed therein may be placed between a pair of metal plates, and the particles may be pulverized into a predetermined particle size after being fired between 200° C. and 80° C. under the applied pressure of, for example, 50 to 5,000 MPa. However, the method is not particularly limited.

Aside from the shape of the negative electrode active material 3a, the inorganic compound 6 as the base material of the negative electrode active material 3a is also important in the present disclosure. The inorganic compound 6 is not particularly limited, as long as it is a compound having lithium ion conductivity. Examples of such compounds include compounds containing oxygen, such as SiO₂ , B₂O₃, and P₂O₅, compounds containing lithium, such as Li₂S—P₂S₅, Li₃N, Li₁₀GeP₂S₁₂, Li_{3.25}Ge_{0.25}P_{0.75}S₄, Li₂S—B₂S₅—LiI, and Li₂S—GeS₂, and compounds containing oxygen and lithium, such as Li₃BO₃, Li₃PO₄, Li₂Si₂O₅, Li₂SiO₃, Li₄SiO₄, La_{0.51}Li_{0.34}TiO_{2.94}, Li_{1.5}Al_{0.3}Ti_{1.7}(PO₄)₃, Li₂La₃Zr₂O₁₂,Li_{1.07}Al_{0.89}Ti_{1.46}(PO₄)₃, and Li_{1.5}Al_{0.5}Ge_{1.5}(PO₄)₃.

Preferably, the inorganic compound 6 has lower melting point than silicon. By using an inorganic compound 6 having a lower melting point than silicon, it is possible to sinter only the inorganic compound, without changing the crystal state or the particle size of silicon.

Preferably, the negative electrode active material 3a has a structure with voids 7 inside the particles. As shown in FIG. 7, by containing voids 7 inside the particles of the negative electrode active material 3a, the silicon fine particles 5 undergo volume expansion as lithium ions are stored during charging (the state in (a) of FIG. 7), and volume contraction as the lithium ions are released during discharge (the state in (b) of FIG. 7). Such volume changes of the silicon fine particles 5 can be absorbed by containing voids 7 inside the negative electrode active material 3a. This makes it possible to prevent, for example, cracking due to the volume changes of the silicon fine particles 5, and improve the initial charge and discharge efficiency, and the charge and discharge cycle characteristics. The specific surface area of the silicon fine particles 5 increases when cracking occurs in the negative electrode active material 3a as a result of volume changes of the silicon fine particles 5. This accelerates the side reaction with the nonaqueous electrolytic solution 14, and leads to poor initial charge and discharge efficiency, and poor charge and discharge cycle characteristics. Such deterioration of initial charge and discharge efficiency and charge and discharge cycle characteristics can be reduced by providing the voids 7.

Preferably, the percentage of voids 7 is smaller in the vicinity of the flat surface 8 than in regions of the inorganic compound 6 other than portions in the vicinity of the flat surface 8 in the negative electrode active material 3a. As described above, there is a need to improve the adhesion of the fiat surface 8 for the negative electrode collector 1, and the adhesion between the negative electrode active materials 3a. Such adhesion can be provided when the percentage of the voids is smaller in the vicinity of the flat surface 8, while the voids 7 formed in portions other than the flat surface 8 absorb the volume changes occurring in the silicon fine particles 5 during charge and discharge. This makes it possible to improve charge and discharge cycle characteristics.

The negative electrode active material (second negative electrode active material) 3b has a structure in which the silicon fine particles 5 are dispersed in the inorganic compound 6, and the particles have voids 7, as shown in FIG. 8. Unlike the negative electrode active material 3a, the negative electrode active material 3b does not have a flat surface.

The negative electrode mixture layer 2 may be configured to include only the negative electrode active material 3a. It is, however, preferable to contain both the negative electrode active material 3a and the negative electrode active material 3b. The ratio of the negative electrode active material 3a and the negative electrode active material 3b (negative electrode active material 3a/negative electrode active material 3b) is preferably larger than 0.01 and smaller than 1.0. As shown in FIG. 9, the proportion of the flat surface 8 with small surface roughness increases when the ratio of the negative electrode active material 3a and the negative electrode active material 3b is 1.0 or more. This decreases the specific surface, areas of the negative, electrode active materials 3a and 3b containing the silicon fine particles 5, and the contact area between the negative electrode active materials 3a and 3b, and the nonaqueous electrolytic solution 14 becomes smaller. A smaller contact area between the negative electrode active materials 3a and 3b, and the nonaqueous electrolytic solution 14 leads to reduced storage and release amounts of lithium ions, and the input/output characteristics suffer. Referring to FIG. 10, when the ratio of the negative electrode active material 3a and the negative electrode active material 3b is 0.01 or less, the flat surface 8 becomes smaller, and the charge and discharge cycle characteristics suffer as the flat surface 8 fails to provide the adhesion improving effect between the negative electrode active materials 3a and 3b and the negative electrode collector 1, and between the negative electrode active materials 3a and 3b.

The negative electrode mixture layer 2 may contain the negative electrode active material (third negative electrode active material) 3c, in addition to the negative electrode active material 3a, or in addition the negative electrode active material 3a and the negative electrode active material 3b. The negative electrode active material 3c is not particularly limited, and may be a carbon material such as graphite.

When a carbon material such as graphite is used in the negative electrode mixture layer the ratio of the particles of the negative electrode active material 3a and the negative electrode active material 3b, and a carbon material such as graphite (graphite particles/(the total amount of negative electrode active material 3a and negative electrode active material 3b)) is preferably 2.0 to 99.0. High capacity and improved cycle characteristics can be achieved at the same time when the ratio falls in this range. The proportion of silicon fine particles 5 that contribute to high capacity decreases, and the capacity improving effect becomes weaker when the ratio of the particles of the negative electrode active material 3a and the negative electrode active material 3b and the carbon material is larger than 99.0. When the ratio is smaller than 2.0, the proportion of graphite particles that contribute to electron conduction becomes smaller, and the electron conductivity suffers.

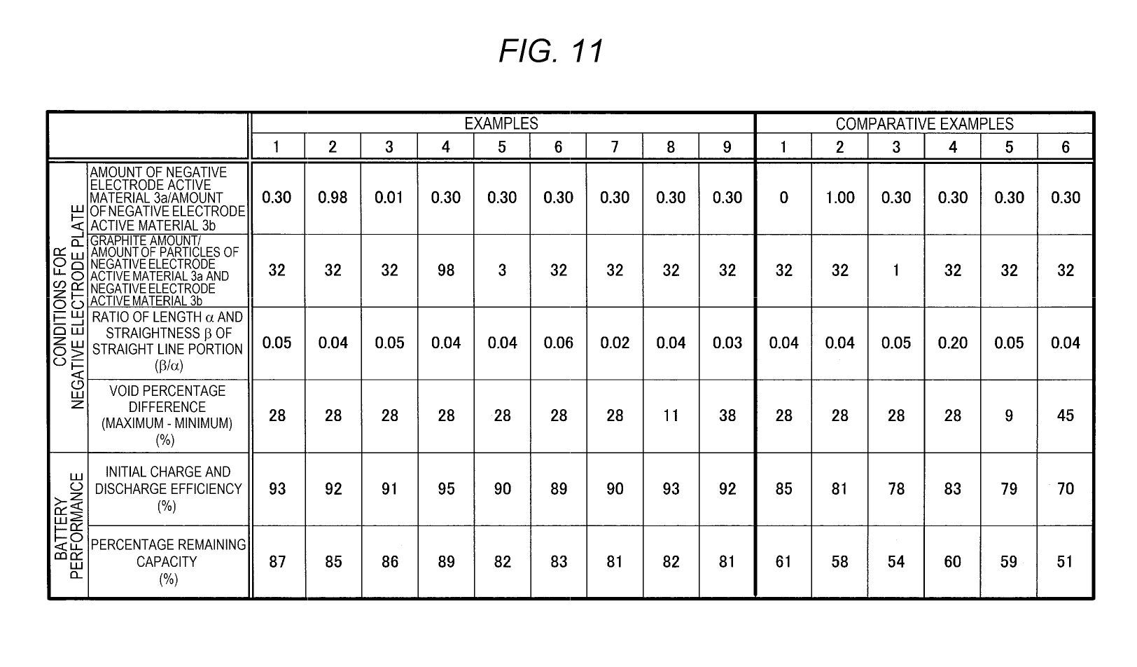

The following are Examples and Comparative Examples of the embodiment of the present disclosure. The present disclosure, however, is not limited by the following descriptions. FIG. 11 is a diagram representing the results of battery performance measurements performed in Examples 1 to 9 and Comparative Examples 1 to 9.

The positive electrode plate 11, the separator 13, the nonaqueous electrolytic solution 14, and the casing 15 are the same across Examples 1 to 9, and Comparative Examples 1 to 6.

The positive electrode plate 11 uses a 15 μm-thick aluminum foil as the positive electrode collector, and the positive electrode mixture layer provided on the both surfaces thereof includes 100 weight parts of active material lithium cobalt oxide, 5 weight parts of conduction aid acetylene black, and 5 weight parts of binder polyvinylidene fluoride. The thickness of the positive electrode mixture layer is 30 μm each side.

A 27 μm-thick polypropylene porous film was used as the separator 13. The nonaqueous electrolytic solution 14 is a solution of 1 mol/L of solute lithium hexafluorophosphate dissolved in a solvent prepared by mixing ethylene carbonate, dimethyl carbonate, and ethyl methyl carbonate at a weight ratio of 1:1:1. A cylindrical casing having a diameter of 26 mm and a height of 65 mm was used as the casing 15.

The negative electrode plate 12 is configured from a negative electrode collector 1 formed as a 10 μm-thick electrolytic copper foil, and negative electrode mixture layers 2 provided on the both surfaces of the negative electrode collector 1. The negative electrode mixture layers 2 include the negative electrode active 25 material 3a, the negative electrode active material 3b, the negative electrode active material 3c, and the binder 4, and each have a thickness of 50 μm. The negative electrode active material 3a, and the negative electrode active material 3b are configured from the inorganic compound 6 containing the silicon fine particles 5. Graphite was used as the active material of the negative electrode active material 3c. The negative electrode mixture layer 2 used 100 weight parts of a mixed powder of active material graphite and an inorganic compound containing silicon fine particles, 1 weight part of carboxylmethyl cellulose used as the binder 4, and 2 weight parts of styrene-butadiene rubber. These configurations are the same across Examples and Comparative Examples. However, Examples and Comparative Examples use different conditions with regard to the characteristic conditions of the present disclosure, specifically the ratio of the negative electrode active material 3a and the negative electrode active material 3b, the ratio of the total particle amount of the negative electrode active materials 3a and 3b, and the graphite, the ratio (β/α) of the length α and the straightness β of the straight line portion of the flat surface 8 of the negative electrode active material 3a, and the difference in the void percentage between a region in the vicinity of the flat surface 8 and other portions in the negative electrode active material 3a, as summarized in FIG. 11.

For the calculation of the difference in the void percentage in the negative electrode active material 3a, a particle cross section of the negative electrode active material 3a in an SEM image was divided into five portions, and a void percentage was measured through image processing in a region in the vicinity of the flat surface 8 and in other portions. The difference between the maximum value and the minimum value was then calculated.

A collector produced by winding the positive electrode plate 11 and the negative electrode plate 12 in layers with the separator 13 in between was housed inside the casing 15 with the nonaqueous electrolytic solution 14 to produce lithium-ion secondary batteries of Examples 1 to 9 and Comparative Examples 1 to 6.

Each battery was charged and discharged in a 25° C. environment under a constant current of 400 mA with an upper limit voltage of 4.2 V for charging, and a lower limit voltage of 2.5 V for discharge, and measured for charge capacity (mAh) and discharge capacity (mAh). The charge and discharge procedure was repeated 500 times in a cycle, and the charge capacity and the discharge capacity after 500 cycles were measured. The measurement results were then used to calculate initial charge and discharge efficiency and percentage remaining capacity. The initial charge and discharge efficiency was calculated by “(discharge capacity after 1 cycle/charge capacity after 1 cycle)×100%”. The percentage remaining capacity was calculated by “(discharge capacity after 500 cycles/discharge capacity after 1 cycle)×100%”. The results of calculations are presented in FIG. 11.

As is clear from the results shown in FIG. 11, high percentages of remaining capacity were achieved in all batteries of Examples 1 to 9 of the present disclosure, and the batteries can achieve the desirable charge and discharge cycle characteristics required in applications such as in automobiles. Relative to Examples 1 to 9, the percentage remaining capacity was lower in all of the batteries of Comparative Examples 1 to 6 that fall outside of the scope of the present disclosure, and these batteries fail to satisfy the required levels of charge and discharge cycle characteristics in applications such as in automobiles.

### INDUSTRIAL APPLICABILITY

The present disclosure can improve the charge and discharge cycle characteristics, and is useful in applications such as in lithium-ion secondary batteries that include a negative electrode plate including a negative electrode collector and a negative electrode mixture layer, and a positive electrode plate.

What is claimed is:

1. A lithium-ion secondary battery comprising:
a positive electrode plate including a positive electrode collector, and a positive electrode, mixture layer provided in contact with a surface of the positive electrode collector;
a negative electrode plate including a negative electrode collector, and a negative electrode mixture layer provided in contact with a surface of the negative electrode collector; and
a separator provided between the positive electrode plate and the negative electrode plate,
the positive electrode plate, the negative electrode plate, and the separator being housed in a casing with an electrolytic solution,
wherein the negative electrode mixture layer includes at least a first negative electrode active material, and a binder that anchors the first negative electrode active material on a surface of the negative electrode collector,
wherein the first negative electrode active material has a structure in which silicon fine particles are dispersed in at least an inorganic compound, and
wherein the first negative electrode active material has a flat surface in at least a part of its surface.

2. The lithium-ion secondary battery according to claim 1, wherein the inorganic compound has a lower melting point than silicon.

3. The lithium-ion secondary battery according to claim 1, wherein the inorganic compound is an inorganic compound containing oxygen.

4. The lithium-ion secondary battery according to claim 1, wherein the inorganic compound is an inorganic compound containing lithium.

5. The lithium-ion secondary battery according to claim 1, wherein the first negative electrode active material has voids inside the inorganic compound.

6. The lithium-ion secondary battery according to claim 5, wherein the percentage of the voids is smaller in the vicinity of the flat surface than in other regions.

7. The lithium-ion secondary battery according to claim 1, wherein the negative electrode mixture layer further includes a second negative electrode active material, and the second negative electrode active material has a structure in which silicon fine particles are dispersed in at least an inorganic compound, and wherein the flat surface is provided only on the first negative electrode active material.

8. The lithium-ion secondary battery according to claim 7, wherein the negative electrode mixture layer includes the second negative electrode active material in a larger amount than the first negative electrode active material.

9. The lithium-ion secondary battery according to claim 8, wherein the first negative electrode active material and the second negative electrode active material have such proportions that 0.01<the first negative electrode active material/the second negative electrode active material<1.0.

10. The lithium-ion secondary battery according to claim 7, wherein the negative electrode mixture layer further includes a third negative electrode active material comprised of a graphite powder.

11. The lithium-ion secondary battery according to claim 1, wherein the silicon fine particles in the first negative electrode active material are larger than 5 nm and less than 1,000 nm.

12. The lithium-ion secondary battery according to claim 1, wherein the silicon fine particles in the first negative electrode active material are larger than 5 nm and less than 200 nm.

13. The lithium-ion secondary battery according to claim 1, wherein in the flat surface of the first negative electrode active material a ratio (β/α) of length α and straightness β is preferably less than 0.07.
